(19) United States
(12) Patent Application Publication
(10) Pub. No.: US 2017/0341577 A1
(43) Pub. Date: Nov. 30, 2017

(54) Driver Alert System

(71) Applicant: Pattie Pool, Placerville, CA (US)

(72) Inventor: Pattie Pool, Placerville, CA (US)

(21) Appl. No.: 15/163,869

(22) Filed: May 25, 2016

(51) Int. Cl. B60Q 9/00

(52) U.S. Cl. CPC B60Q 9/008

(57) ABSTRACT

A driver alert system includes a vehicle that may be driven. A sensing array is coupled to the vehicle and the sensing array may detect an object. The sensing array emits an audible alarm when the sensing array detects the object. Thus, the sensing unit may alert a driver of the vehicle that the vehicle is within a trigger distance of the object. The sensing array is distributed around an entire perimeter of the vehicle to detect the object on any side of the vehicle.

### BACKGROUND OF THE DISCLOSURE

### Field of the Disclosure

The disclosure relates to alert devices and more particularly pertains to a new alert device for alerting a driver to an object during vehicular operation.

### SUMMARY OF THE DISCLOSURE

An embodiment of the disclosure meets the needs presented above by generally comprising a vehicle that may be driven. A sensing array is coupled to the vehicle and the sensing array may detect an object. The sensing array emits an audible alarm when the sensing array detects the object. Thus, the sensing unit may alert a driver of the vehicle that the vehicle is within a trigger distance of the object. The sensing array is distributed around an entire perimeter of the vehicle to detect the object on any side of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a driver alert system according to an embodiment of the disclosure.

FIG. 2 is a front view of an embodiment of the disclosure.

FIG. 3 is a left side phantom view of an embodiment of the disclosure.

FIG. 4 is a schematic view of an embodiment of the disclosure.

### DESCRIPTION OF THE PREFERRED EMBODIMENT

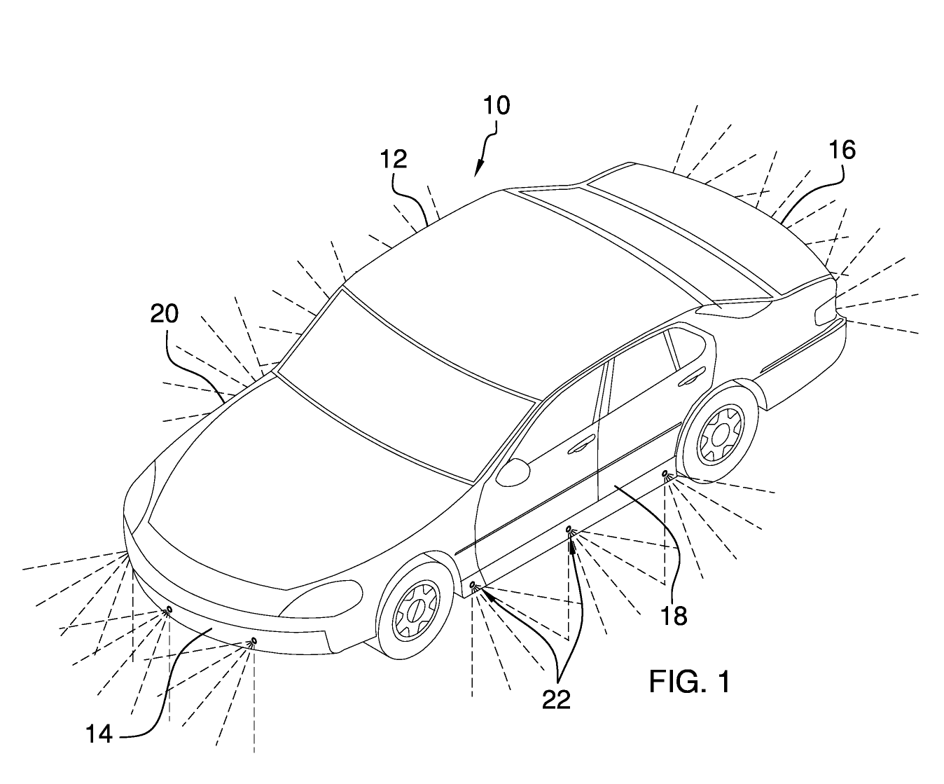

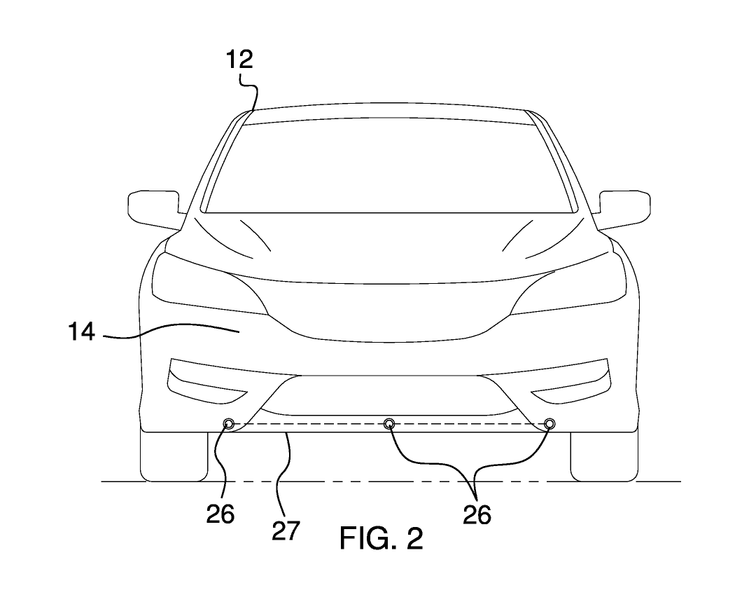

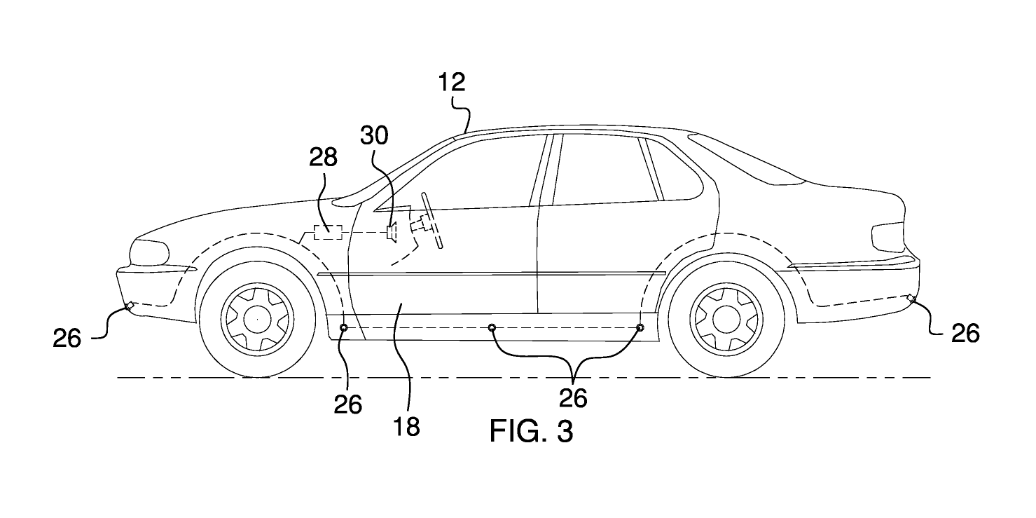

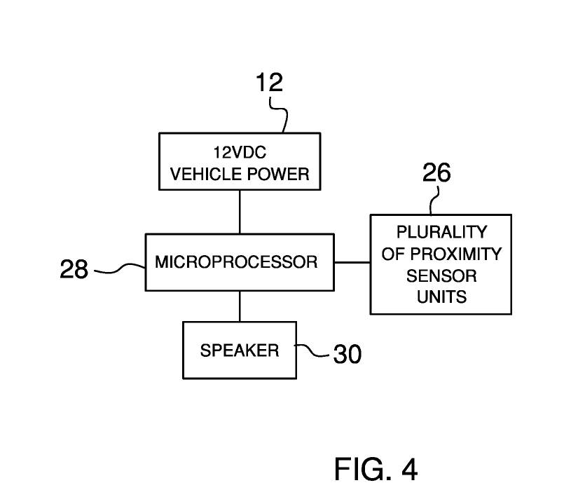

With reference now to the drawings, and in particular to FIGS. 1 through 4 thereof, a new alert device embodying the principles and concepts of an embodiment of the disclosure and generally designated by the reference numeral 10 will be described.

As best illustrated in FIGS. 1 through 4, the driver alert system 10 generally comprises a vehicle 12 that may be driven. The vehicle 12 has a front side 14, a back side 16, a first lateral side 18 and a second lateral side 20. The vehicle 12 may comprise a passenger vehicle or the like. A sensing array 22 is coupled to the vehicle 12. The sensing array 22 detects an object 24. The object 24 may comprise a curb, an additional vehicle or any extrinsic object with respect to the vehicle 12. The object 24 poses a threat to the vehicle 12 if the vehicle 12 strikes the object 24.

The sensing array 22 emits an audible alarm when the sensing array 22 detects the object 24. Thus, the sensing array 22 alerts a driver of the vehicle 12 that the vehicle 12 is within a trigger distance of the object 24. The trigger distance may be a distance ranging between approximately one meter and three meters. The sensing array 22 is distributed around an entire perimeter of the vehicle 12. Thus, the sensing array 22 may detect the object 24 on any side of the vehicle 12.

The sensing array 22 comprises a plurality of proximity sensors 26. Each of the proximity sensors 26 is coupled to the vehicle 12 and the proximity sensors 26 are spaced apart from each other. The proximity sensors 26 are distributed around the front side 14, the first lateral side 18, the second lateral side 20 and the back side 16 of the vehicle 12. Each of the proximity sensors 26 may comprise an electronic proximity sensor or the like. Additionally, each of the proximity sensors 26 may be aligned with a bottom edge 27 of the vehicle 12.

A processor 28 is positioned within the vehicle 12 and the processor 28 is electrically coupled to the vehicle 12. The processor 28 is electrically coupled to each of the proximity sensors 26. The processor 28 generates an alarm sequence when one of the proximity sensors 26 detects the object 24 within the trigger distance of the vehicle 12. The processor 28 may comprise an electronic processor or the like.

A speaker 30 is positioned within the vehicle 12 and the speaker 30 is electrically coupled to the processor 28. The speaker 30 emits an audible alarm when the processor 28 generates the alarm sequence. Thus, the speaker 30 may alert the driver that the vehicle 12 is within the trigger distance of the object 24. The speaker 30 may comprise an electronic speaker or the like.

In use, the vehicle 12 is driven in the convention of vehicle operation. The speaker 30 emits the audible alarm when the vehicle 12 travels to within the trigger distance of the object 24. Thus, the driver of the vehicle 12 is alerted to the potential danger of striking the object 24 with the vehicle 12. The sensing array 22 assists the driver to park the vehicle 12 without striking the object 24 and to drive the vehicle 12 without striking the object 24.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A driver alert system comprising:
a vehicle being configured to be driven, said vehicle has a front side, a first lateral side, a second lateral side and a back side; and
a sensing array being coupled to said vehicle wherein said sensing array is configured to detect an object, said sensing array emitting an audible alarm when said sensing array detects the object wherein said sensing array is configured to alert a driver of the vehicle that the vehicle is within a trigger distance of the object, said sensing array being distributed around an entire perimeter of said vehicle wherein said sensing array is configured to detect the object on any side of said vehicle, said sensing array comprising a plurality of proximity sensors, each of said proximity sensors being coupled to said vehicle, said proximity sensors being spaced apart from each other and being distributed around said front side, said first lateral side, said second lateral side and said back side of said vehicle, each of said proximity sensors being aligned with a bottom edge of said vehicle.

2. (canceled)

3. (canceled)

4. The system according to claim 3, further comprising a speaker being positioned within said vehicle, said speaker being electrically coupled to said processor, said speaker emitting an audible alarm when said processor generates said alarm sequence wherein said speaker is configured to alert the driver that the vehicle is within said trigger distance of the object.

5. A driver alert system comprising:
a vehicle being configured to be driven, said vehicle having a front side, a back side, a first lateral side and a second lateral side; and
a sensing array being coupled to said vehicle wherein said sensing array is configured to detect an object, said sensing array emitting an audible alarm when said sensing array detects the object wherein said sensing unit is configured to alert a driver of the vehicle that the vehicle is within a trigger distance of the object, said sensing array being distributed around an entire perimeter of said vehicle wherein said sensing array is configured to detect the object on any side of said vehicle, said sensing array comprising:
a plurality of proximity sensors, each of said proximity sensors being coupled to said vehicle, said proximity sensors being spaced apart from each other and being distributed around said front side, said first lateral side, said second lateral side and said back side of said vehicle, each of said proximity sensors being aligned with a bottom edge of said vehicle;
a processor being positioned within said vehicle, said processor being electrically coupled to said vehicle, said processor being electrically coupled to each of said proximity sensors, said processor generating an alarm sequence when one of said proximity sensors detects the object within the trigger distance of said vehicle; and
a speaker being positioned within said vehicle, said speaker being electrically coupled to said processor, said speaker emitting an audible alarm when said processor generates said alarm sequence wherein said speaker is configured to alert the driver that the vehicle is within said trigger distance of the object.
